(19) United States
(12) Patent Application Publication
(10) Pub. No.: US 2009/0043655 A1
(43) Pub. Date: Feb. 12, 2009

(54) Rewards System Providing Incentive to Make Choices That Benefit the Environment

(75) Inventor: James A. Westbrook, JR., San Diego, CA (US)

Correspondence Address: WINTHROP D. CHILDERS, 9855 FOX VALLEY WAY, SAN DIEGO, CA, 92127, US

(73) Assignee: James A. Westbrook, JR., San Diego, CA (US)

(21) Appl. No.: 12/183,765

(22) Filed: Jul. 31, 2008

Related U.S. Application Data
(60) Provisional application No. 60/955,034, filed on Aug. 9, 2007.

(51) Int. Cl. G06Q 30/00

(52) U.S. Cl. 705/14

(57) ABSTRACT

The present invention concerns a system and method for providing an incentive to consumers and business to make choices that benefit the environment. Each consumer and/or business has an account. The account accumulates redeemable reward points based upon transaction information and at least one environmental factor that is based upon how transaction choices benefit the environment.

### RELATED APPLICATIONS

This non-provisional application claims priority to U.S. Provisional Application Ser. No. 60/955,034 entitled “Rewards System Providing Incentive to Make Choices That Benefit the Environment” by James A. Westbrook, Jr., filed on Aug. 9, 2007, incorporated herein by reference under the benefit of U.S.C. 119(e).

### FIELD OF THE INVENTION

The present invention concerns a reward point system that encourages consumers and/or businesses to make choices that benefit the environment.

### BACKGROUND

Rising populations and expected living standards are causing industries and homes to put increasing pressure on the global environment. Pressures include pollution and depletion of natural resources. Natural resources include natural environments such as rain forests as well as extractable resources such as petroleum and minerals. Pollution includes water borne and airborne waste products such as carbon dioxide emissions.

Byproducts of these pressures include rising costs of resources and long term damage to the environment. Perhaps the most widely discussed recent byproduct is global warming. Scientists worldwide have expressed increasing concern that carbon-based emissions will result in increased global temperatures that cause devastating climate-related change. This has raised no small concern in the general population. A number of large companies are just now systematically addressing these issues of environmental sustainability.

But despite the concern, most individuals make “day to day” decisions that negatively impact the environment. People may have immediate consumption needs and commitments related to management of personal affairs that take precedence over longer term considerations such as natural resource shortages, pressures on ecosystems, and climate change. As a result, a lot of seemingly small decisions are made without regard for the environment. Examples of such decisions include selection of an automobile based on emissions, method and use of heating and air conditioning, incandescent versus fluorescent light bulbs, etc. The aggregate of these decisions for billions of consumers can have very large global repercussions. What is needed is a system to encourage companies and consumers to make choices that will provide a large aggregate benefit to the environment. The impact of these choices will be the high value that comes from a better quality of life.

### BRIEF DESCRIPTION OF THE DRAWINGS

FIG. 1 depicts a block diagram representation of an information technology ecosystem that enables the present invention.

FIG. 2 depicts a flow chart representation of a method of setting up an account.

FIG. 3 depicts a flow chart representation of a method of awarding points.

FIG. 4 depicts a flow chart representation of a method of computing an award level.

FIG. 5 depicts a flow chart representation of a method of awarding and redeeming points.

### DETAILED DESCRIPTION OF THE PREFERRED EMBODIMENTS

According to the present invention, an award system is configured to award transactions between consumers and businesses (or between businesses) in a way that provides an incentive to make choices that are most beneficial to the environment. In an exemplary embodiment, the award system is an IT (information technology) system that is configured to store environmental factor information and consumer account information and to manage information related to consumer purchases from retail establishments.

The environmental factor information includes environmental factors for consumers and approved businesses. To be approved a business must reflect a level of financial commitment to the environment, following approval steps. For example, a retailer may be required to have written a sustainability plan, commit to open disclosure and reduction of carbon emissions, and show progress toward environmentally sustainable practices. An environmental factor is indicative of a level of commitment.

Consumer account information defines information pertaining to each consumer who has elected to establish an account with the award system. The account information includes reward points accumulated and may include a consumer environmental commitment level factor.

Although the discussion infra will refer to transactions between consumers and retail establishments, it is to be understood that the method of the present invention may equally apply to transactions between businesses and retail establishments. For example, an owner or employee of a business may make a purchase at a retail establishment that serves businesses and consumers.

The award system manages information related to consumer and/or business transactions. When a consumer makes a purchase, the award system uses environmental factor information pertaining to the purchase to compute award points that are then added to the consumer's account. Accumulated award points are portable—they may be redeemed at a number of different approved businesses.

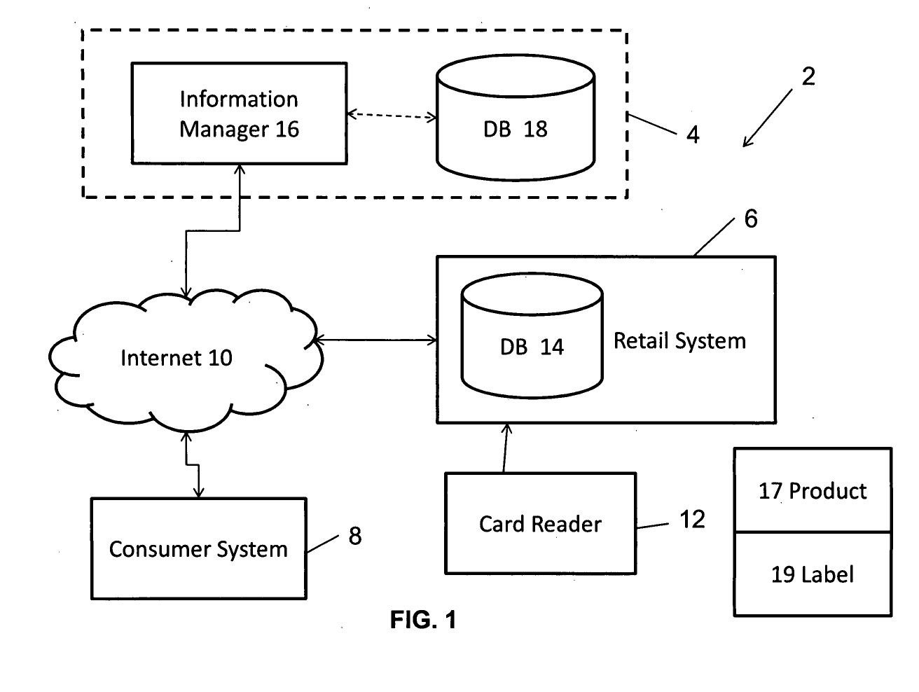

FIG. 1 depicts a block diagram representation of an information ecosystem 2 according to the present invention. Information ecosystem 2 includes an award system 4, a retail system 6, and a consumer system 8 all coupled to a network 10 such as the internet.

Retail system 6 is an IT (information technology) system used by a retail establishment. It is coupled to a reader 12 for reading debit, credit, and/or award cards. Typically, reader 12 is positioned near a cash register. Reader 12 is configured to read one or more of magnetic stripes, bar codes, RFID chips, or other information storage elements of a card.

Retail system 6 includes a retail system database 14 that stores information such as information about purchases along with information about customers of the retail establishment. Retail system 6 may also be coupled to other devices not shown such as cash registers and inventory control systems.

In another embodiment retail system 6 is an IT system for an on line retailer or business. For such an embodiment, retail system 6 does not require reader 12.

Consumer system 8 is an IT device used by a consumer such as a personal computer or laptop computer. In addition, consumer system 8 may be one of a number of devices such as palm top computers, notebook computers, cellular phones, PDA's (personal digital assistants) and other devices that couple to internet 10 and enable shopping at a retail establishment such as an online retailer or an online division of a conventional retail establishment. Consumer system 8 is also configured to communicate with award system 4 via internet 10.

Award system 4 is configured to create and manage rewards accounts that encourage consumers to make choices that benefit the environment. Award system 4 includes information manager 16 and award system database 18. Information manager 16 manages information within award system 4 and information transfer between award system 4 and other systems such as retail system 6 and consumer system 8. Award system database 18 is configured to store information pertaining to products, retailers and consumers.

Database 18 stores consumer account information defining each consumer account. For each account, this includes information defining accumulated award points. In a preferred embodiment, the consumer account information includes a consumer environmental commitment factor that affects how many points are awarded for a given purchase.

A consumer environmental commitment factor is determined pursuant to the consumer's financial commitment to the environment. Examples of financial commitments include the purchase of a hybrid automobile or a solar heating system, and purchase of carbon offsets. When a consumer makes such an investment, the level of the environmental commitment factor is increased to reflect the financial commitment. This higher level enables the consumer to obtain more award points for a given purchase.

Database 18 stores information defining a list of approved retail establishments. Based on their financial commitment to the environment, retail establishments earn a retail establishment certification level factor in system 4. A higher certification level factor results in greater points being awarded to the consumer for a given purchase at the retail establishment.

Database 18 stores information defining a list of approved products or services. Based on their relative benefit to the environment, each product or service has a product certification level factor. This factor directly determines how many points are awarded based upon a purchase of the product or service.

In one embodiment a product 17 being purchased bears a tag 19 that indicates that the product 17 has a particular product certification level factor. The tag 19 may be a visible label 19 for a consumer or cashier, an RFID tag 19 readable by a retail system 6 (such as by an RFID reader), a barcode readable by system 6 (such as by a checkout scanner), or any combination thereof, to name a few examples of tag 19.

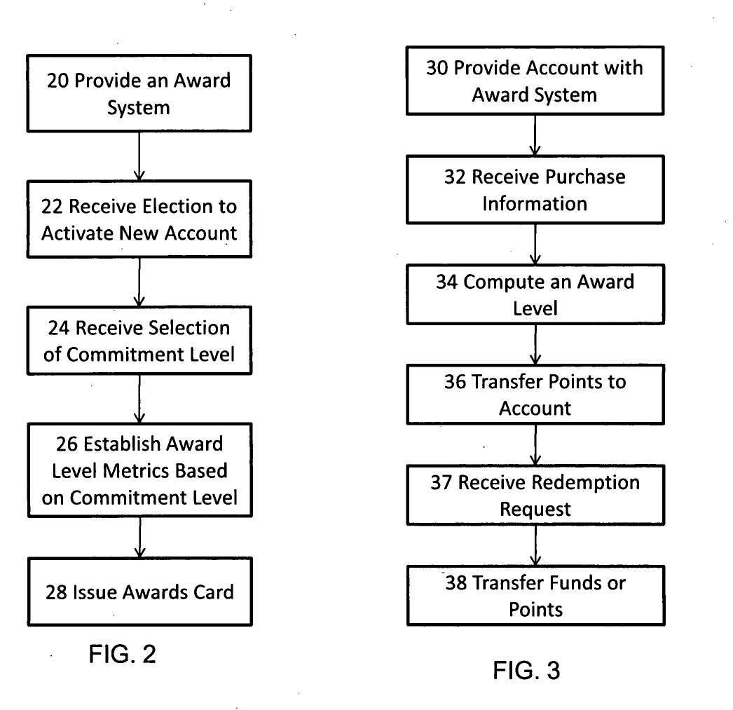

FIG. 2 depicts a flow chart representation of a method of establishing a new account. According to 20 award system 4 is provided. According to 22, award system 4 receives information defining an election to activate a new account. The information may include a customer name, address, phone number, email address, etc. In one embodiment, the information is transmitted electronically from a consumer system 8. In another embodiment, the information may arrive by mail. In yet another embodiment the information may arrive from a retail system 6 if the customer fills out a form at an in-store retailer. Regardless of how the request arrives, a new account for the customer is established.

According to 24, award system 4 receives information defining an environmental commitment level for the new account. Step 24 may occur upon initially establishing the account or it may occur later after the account is established. In one embodiment, there is a “default” commitment level that is the lowest level of environmental commitment. A higher level may be obtained by making a substantial financial commitment to the environment such as by purchasing a hybrid car or installing a solar heating system.

According to 26, award system 4 assigns award level metrics to the account based upon the environmental commitment level. The award level metrics may include an environmental commitment level factor that is utilized by award system 4 in computing an amount of points that are awarded for a given purchase.

According to 28, award system 4 issues an awards card to the consumer. In one embodiment, the consumer receives the award card by mail. In a second embodiment, an existing credit card is upgraded to being an awards card according to 28. In a third embodiment, the consumer receives an account number that is indicative of the new account along with a pin (personal ID number) used along with the account number.

FIG. 3 depicts a flow chart representation of a method of awarding points based on a consumer purchase from a retail establishment. According to 30, a consumer has an account with award system 4.

According to 32, award system 4 receives purchase information indicative of a consumer purchase from a retail establishment. In one embodiment the purchase information includes human read or scanned information from tag 19. This purchase information would also include account information indicative of an account the consumer has with award system 4.

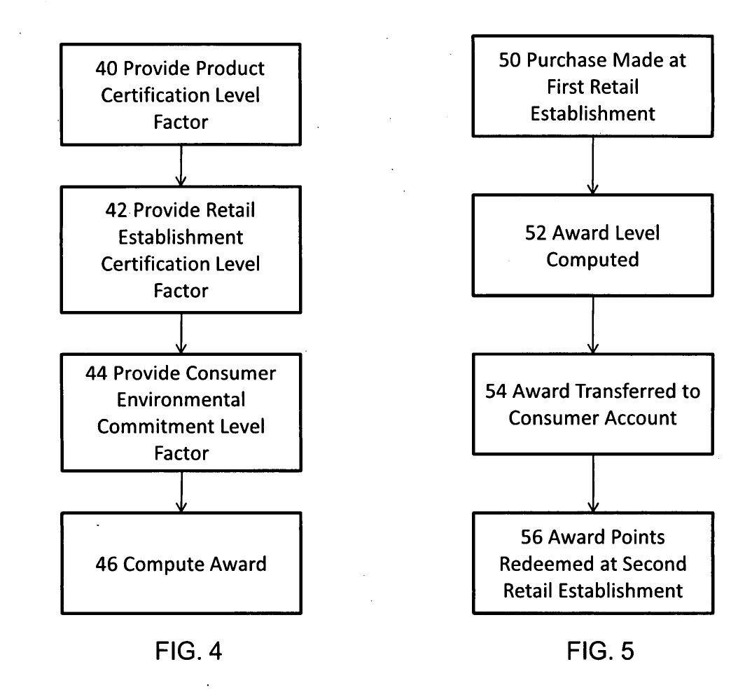

According to 34, an award level is computed based upon at least one environmental factor. In an exemplary embodiment, the award level is computed by way of a method similar to that described infra with respect to FIG. 4 According to 36; award points are transferred to the consumer's account.

According to 37 and 38, award points are redeemed. In an exemplary embodiment, the consumer uses the award points to make a purchase at an approved retail establishment. The consumer chooses a product to buy and then chooses to use accumulated award points. According to 37, award system receives a request from retail system 6 to redeem points from the consumer's account. According to 38, including an approval process, the award system electronically transfers funds to retail system 6 to allow the redemption to take place.

Other methods of redeeming award points are possible such as providing cash, airline mileage points, gift certificates, or rebates on purchases to name a few. Award system 4 may redeem points by transferring funds or points according to 38.

FIG. 4 depicts a flow chart representation of a method of computing an award level for a given purchase such as the purchase discussed supra with respect to FIG. 3. According to 40, a product certification level factor is provided. This factor is dependent upon the amount by which purchase of a product as opposed to an alternative product benefits the environment. This factor may define a nominal number of award points for a given product purchase.

According to 42, a retailer certification level factor is provided. This factor is based upon a commitment level of a retailer to the environment. For an approved retailer, this factor increases the number of award points depending upon the commitment level.

According to 44 a consumer environmental commitment level factor is provided. A higher level of commitment will further increase the number of points awarded for a given product purchase. According to 46 the award points are computed based on the factors determined in steps 40-44.

As an example, suppose a consumer purchases an environmentally friendly product such as fluorescent light bulbs. Suppose that due to the energy efficiency relative to incandescent bulbs, the nominal number of points awarded has a value equal to 2% of the purchase price. Suppose that the retailer carrying those bulbs has a high environmental commitment level that provides the retailer with a factor that tends to increase the award value by 50%. Further suppose that the consumer making the purchase has the highest level of commitment to the environment, increasing the award value by another 50%. In this case, the points awarded would have a value equal to 2% times 1.5 times 1.5 or 4.5% of the purchase price. Note that these computations are for illustrative purposes only to explain how multiple factors may be combined to modulate the award level.

FIG. 5 depicts a flow chart representation of a preferred embodiment of the invention. According to 50, a consumer makes a purchase at a first retail establishment. According to 52 an award level is computed. This may be done in a manner similar to that discussed supra with respect to FIG. 4. According to 54, the award points are transferred to the consumer's account in award system 4. According to 56, at least a portion of the award points are redeemed at a second retail establishment. In one embodiment, the second retail establishment is different than the first retail establishment. In one embodiment, points obtained according to 54 from different retail establishments are all equivalent and interchangeable.

According to the method of FIG. 5 award points can be redeemed in any approved retail establishment including the establishments at which award points are received or different retail establishments at which the points are not received. In a preferred embodiment, the award points can only be redeemed at a retail establishment that is environmentally certified or approved by award system 4.

The foregoing disclosure and description of the invention is illustrative and explanatory thereof. Various changes in the details of the illustrated construction may be made within the scope of the appended claims without departing from the spirit of the invention. For example, a retail establishment can be any business from which the consumer make purchases including retailers, on-line retailers, “brick and mortar retailers”, grocery stores, airlines or other transportation services, auto or other rental agencies, service providers of all kinds, restaurants, and clinics, to name a few examples. The purchases can be any kind of purchase such as that of a product, a service, or a ticket for transportation or an event to name a few examples.

What is claimed is:

1. A method of incenting consumers and businesses to make choices that benefit the environment comprising:
providing an account;
receiving purchase information defining a purchase associated with the account;
computing reward points based upon the purchase information and an environmental factor; and
transferring the reward points to the account.

2. The method of claim 1 further comprising:
receiving a redemption request from a retail system; and
transferring funds to the retail establishment.

3. The method of claim 1, wherein the purchase information defines a retail establishment associated with the purchase, the environmental factor includes a retail establishment environmental certification level associated with the retail establishment.

4. The method of claim 1, wherein the purchase information defines a product associated with the purchase, the environmental factor includes a product environmental certification level associated with the product.

5. The method of claim 1, wherein the environmental factor includes consumer environmental commitment level factor associated with the account.

6. The method of claim 1, wherein the reward points may be redeemed through one or more of a plurality of approved retail establishments.

7. The method of claim 1, wherein the purchase information defines a first retail establishment and wherein the reward is redeemable through one or more retail establishments that are different from the first retail establishment.

8. An award system configured to encourage choices that benefit the environment, the award system comprising:
an award system database configured to store environmental factor information and account information, the account information including award points accumulated for each of a plurality of accounts; and
an information manager that computes award point credits for each account based upon purchase information and the environmental factor information.

9. The award system of claim 8 wherein the environmental factor information includes a product certification level factor for each of a plurality of products wherein the product certification level factor for a product is based upon an amount by which the product benefits the environment relative to alternative products and wherein the information manager is configured to compute points that increase based on upon an increasing product certification level factor.

10. The award system of claim 8 wherein the environmental factor information includes a retail certification level factor for each of a plurality of retailers wherein the retail certification level factor for a retailer is based upon a commitment level of that retailer to the environment and wherein the information manager is configured to compute points that increase based upon an increasing retail certification level factor.

11. The award system of claim 8 wherein the environmental factor information includes a consumer environmental commitment factor for each account and wherein the information manager is configured to accumulate points in the account at a more rapid rate for an increasing environmental commitment factor associated with the account.

12. The award system of claim 8 wherein the database is configured to store environmental reward points received from a plurality of different retail establishments.

13. The award system of claim 12 wherein the information manager is configured to enable redemption of award points at the plurality of different retail establishments.

14. The award system of claim 13 wherein the information manager is configured to enable redemption of award points at multiple unrelated retail establishments.

15. A method of providing incentives to benefit the environment comprising:
providing an award system that correlates reward points with a benefit to the environment;
receiving an election to activate an account; and
crediting award points to the account based upon financial commitments that reflect choices that benefit the environment wherein the award points are redeemable at an approved set of retail establishments.

16. The method of 15 further comprising:
receiving transaction information defining a purchase by the account;
providing environmental factor information related to the purchase;
computing award points based upon the transaction information and the environmental factor information; and
crediting the award points to the account.

17. The method of claim 16 wherein the environmental factor is one or more of a product certification level factor, a retailer certification level factor, and an environmental commitment level factor.

18. The method of claim 16 wherein the purchase is performed at a first retail establishment and further comprising:
receiving a redemption of the award points at a second retail establishment that is a competitor to the first retail establishment; and
processing the redemption for the second retail establishment.

19. The method of claim 16 wherein the purchase is performed at a first retail establishment and further comprising:
receiving a redemption of the award points at a second retail establishment that is unrelated and unaffiliated with the first retail establishment.

20. The method of claim 16 wherein the purchase is performed at a first retail establishment and further comprising:
receiving a redemption of the award points at a second retail establishment that is in a different business sector than the first retail establishment.
